(19) United States
(12) Patent Application Publication
(10) Pub. No.: US 2018/0058021 A1
(43) Pub. Date: Mar. 1, 2018

(54) LUMINESCENT RAISED PAVEMENT MARKER

(71) Applicants: Andrew Lee, Fort Lauderdale, FL (US); ZhiQiang Liu, Shanghai (CN); Gang Li, Shanghai (CN)

(72) Inventors: Andrew Lee, Fort Lauderdale, FL (US); ZhiQiang Liu, Shanghai (CN); Gang Li, Shanghai (CN)

(21) Appl. No.: 15/790,652

(22) Filed: Oct. 23, 2017

Related U.S. Application Data
(63) Continuation-in-part of application No. 15/142,855, filed on Apr. 29, 2016, now abandoned.
(60) Provisional application No. 62/154,185, filed on Apr. 29, 2015.

(51) Int. Cl. E01F 9/559; E01F 9/565; E01F 9/506; F21S 8/00; C09K 11/08

(52) U.S. Cl. CPC E01F 9/559; E01F 9/565; C09K 11/0822; F21S 8/032; E01F 9/506

(57) ABSTRACT

A raised pavement marker (RPM) is sized and configured to comply with Department of Transportation requirements and includes a main body with a top side, opposite angled side faces, opposite ends and a bottom surface structured to be bonded to a road surface. A sheet substrate is coated on a top surface with multiple layers of a photoluminescent composition containing one or more rare earth materials that emits a highly visible glowing light in dark or near dark conditions for at least 6 hours when fully charged. The sheet substrate is inserted within a recessed pocket on the top side of the RPM with the photo-luminescent top surface facing up and is covered by a transparent acrylic lens that is electronically welded to the main body to provide an integral one piece sealed structure. The opposite angled side faces may be fitted with prismatic reflective lenses.

This patent application is a Continuation-In-Part (CIP) of non-provisional patent application Ser. No. 15/142,855 filed on Apr. 29, 2016, which is based on provisional patent application Ser. No. 62/154,185 filed on Apr. 29, 2015.

### BACKGROUND OF THE INVENTION

### Field of the Invention

The present invention relates to raised road markers and, more particularly, to a raised road marker that is at least partially formed of one or more rare earth materials to provide luminescent qualities in dark or near dark environments.

### Discussion of the Related Art

Raised road markers, also referred to as raised pavement markers, are used as safety devices on roads to indicate separation of opposing traffic lanes, location of fire hydrants, access for emergency vehicles, closed traffic areas or wrong direction of vehicle travel (i.e., “Do Not Enter” or “Wrong Way”). Other names for raised road markers include road studs, road cubes, road turtles or simply reflectors. Raised pavement markers are typically molded of a durable plastic material and commonly have two angled sides that face toward drivers approaching from opposite directions. These angled side faces are commonly fitted with reflector strips to enhance visibility of the raised pavement markers, particularly and night. The reflectors may be of various colors to indicate such things as proper direction of travel or closed traffic areas. For instance, when used for lane markings, the opposite angled faces of raised pavement markers may be fitted with a white or yellow reflector on one side to indicate proper direction of travel and a red reflector on the opposite angled face to indicate “Wrong Way” direction of travel.

At night, visibility of raised pavement markers largely depends on use of headlights from approaching vehicles. In some instances, particularly for lane dividers, raised pavement markers may not always be clearly visible at night. Accordingly, there is a definite need for a raised pavement marker that includes a photoluminescent glow-in-the-dark material for enhancing the visibility of the raised pavement marker in dark conditions.

### SUMMARY OF THE INVENTION

The present invention is directed to a raised pavement marker having a main body that is formed at least partially of acrylonitrile butadiene styrene (ABS) and/or a polycarbonate thermoplastic composition. In a preferred embodiment, the top side of the raised pavement marker is provided with a photoluminescent material that is comprised of one or more rare earth materials adapted to be quickly charged with light energy from the sun or headlights of approaching vehicles, and further adapted to emit a luminescent glowing light for an extended period of time. In particular, the present invention proposes to provide one or more inserts each formed of a sheet substrate that is coated with multiple layers of a photoluminescent composition containing rare earth materials. In a preferred embodiment, the photoluminescent insert fits within a recessed pocket on the top of the raised pavement marker. A transparent acrylic lens covers the recessed pocket and insert and is electronically welded to the surrounding edges of the pocket about its entire periphery to provide a complete seal that prevents water intrusion into the pocket and damage to the insert. The acrylic lens forms the top surface of the raised pavement marker, and may be either flat or rounded, such as a dome shape. Prismatic reflective lenses may also be provided on opposite front and rear faces of the raised pavement markers. The prismatic reflective lenses may also be electronically welded to the main body. Moreover, the reflective lenses may be surrounded by a raised peripheral lip integrally molded on the main body to discourage detachment of the reflective lenses.

The rare earth elements used in the photoluminescent composition of the present invention may include, but are not limited to, aluminate photoluminescent pigment, silicate photoluminescent pigment and nitrides photoluminescent pigment.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded top perspective view of the luminescent raised pavement marker of the present invention in accordance with a preferred embodiment thereof;

FIG. 2 is a top perspective view of the assembled luminescent raised pavement marker of FIG. 1;

FIG. 3 is a top plan view of the luminescent raised pavement marker;

FIG. 4 is a bottom plan view of the luminescent raised pavement marker; and

FIG. 5 is a side elevational view of the luminescent raised pavement marker.

Like reference numerals refer to like parts throughout the several views of the drawings.

### DETAILED DESCRIPTION OF THE PREFERRED EMBODIMENTS

The raised pavement marker of the present invention is shown throughout the several views of the drawings and is generally indicated as 10. In each of the embodiments, the raised pavement marker 10 includes a main body 12 having a top surface 14, a front face 16, and opposite rear face 18 and a bottom side 20. The bottom side 20 is structured and disposed to be secured to a ground surface, such as a road surface, with appropriate adhesives that are commonly used for securing raised pavement markers to ground surfaces, such as asphalt, pavement, cement and the like. Specifically, the bottom side 20 is provided with an arrangement of elongate cavities 21 that become at least partially filled with the adhesive material to increase resistance against shearing forces exerted on the raised pavement markers and enhance the bond to the underlying surface.

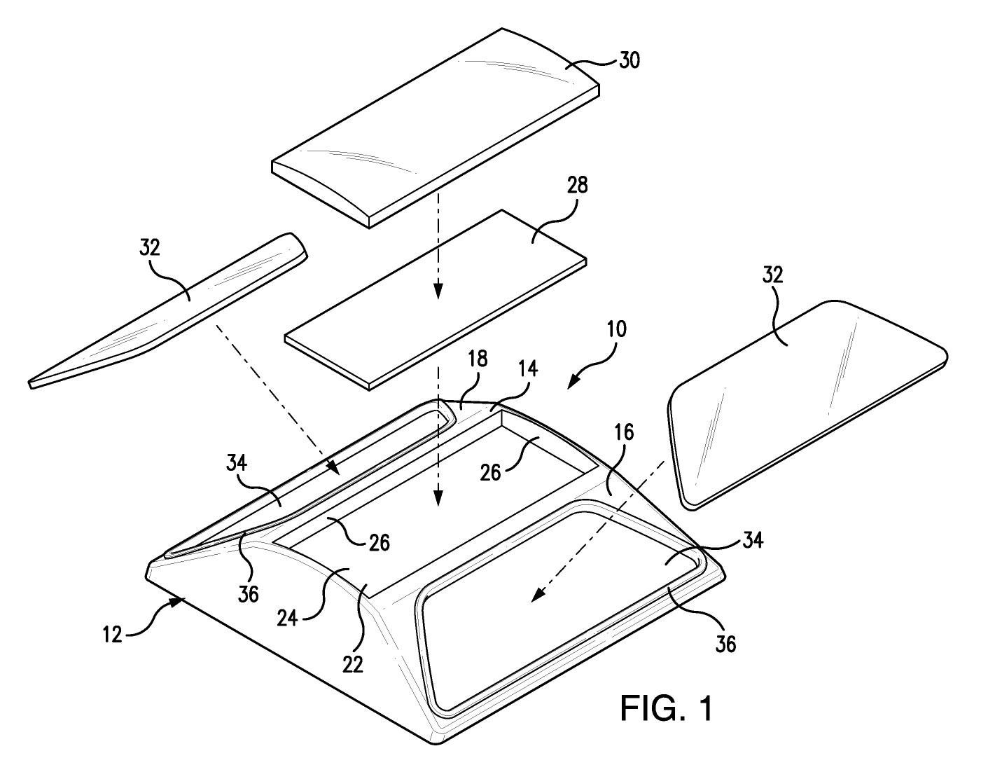

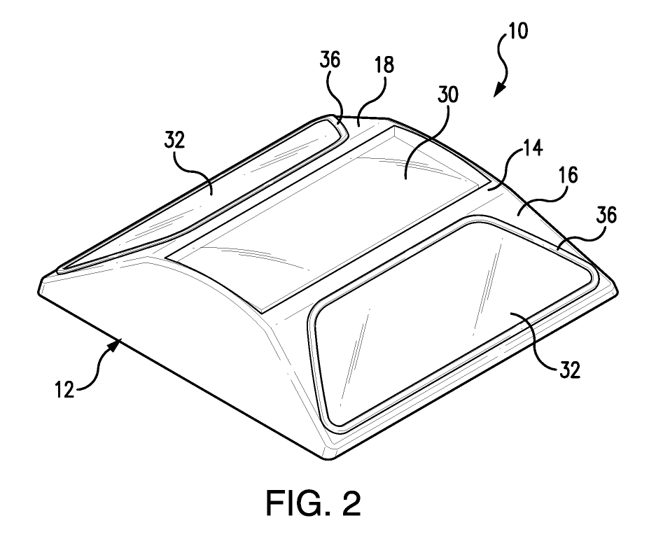

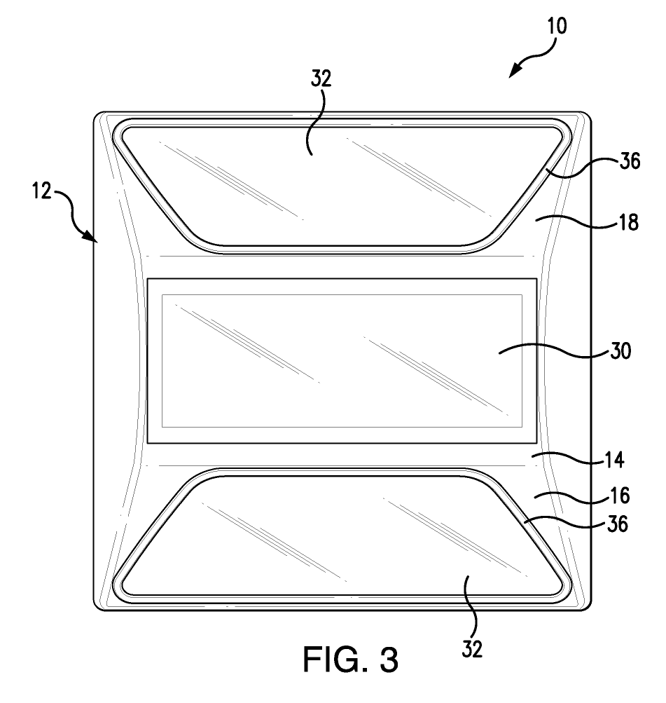

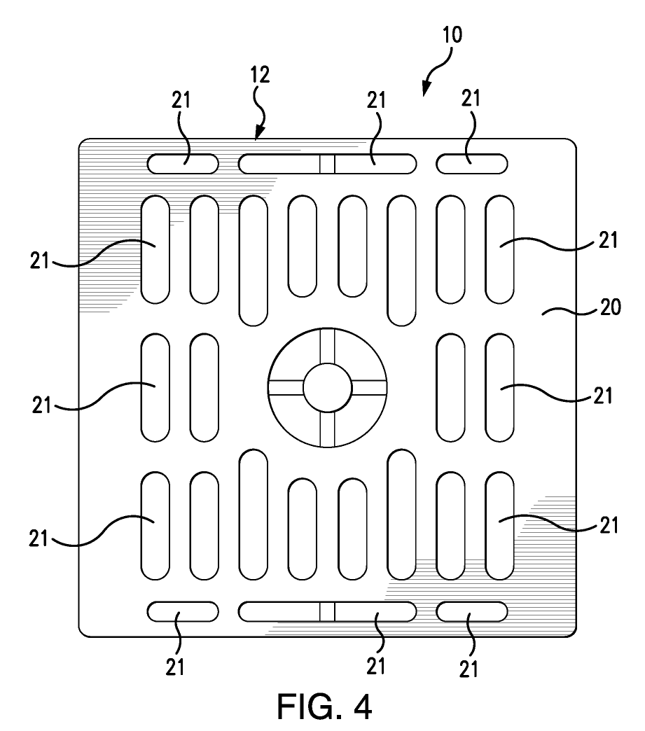

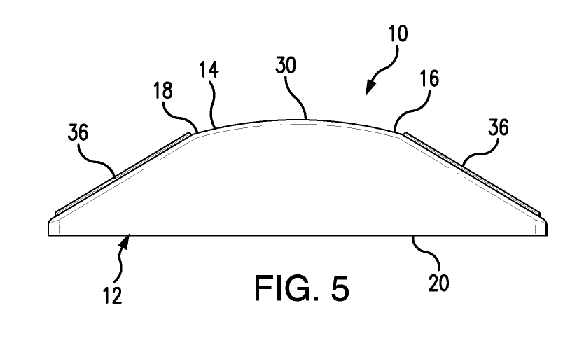

In the embodiment shown in FIGS. 1-5, the main body 12 is formed of a molded plastic material or other suitable composition that is durable and can withstand the harsh environment of an outdoor road surface that is exposed to extreme weather conditions, sunlight and heat, and heavy vehicle traffic. In a preferred embodiment, the main body 12 is molded as an integral one piece unit. Moreover, in a preferred embodiment, the main body 12 is formed of acrylonitrile butadiene styrene (ABS) and/or a polycarbonate thermoplastic composition. The embodiment of the raised pavement marker shown in FIGS. 1-5 further includes at least one insert 28 formed at least partially of a photoluminescent material. In a preferred embodiment, the photoluminescent material is comprised of one or more rare earth materials that are adapted to be quickly charged with light energy from the sun or headlights of approaching vehicles and to emit a luminescent glowing light for an extended period of time. In the preferred embodiment, the insert is formed by applying multiple layers of the photoluminescent composition to a top surface of a sheet of paper substrate having a thickness of between 35 mils to 55 mils.

Referring to FIG. 1, the top surface 14 of the main body 12 includes a recessed pocket 22 having a bottom floor surface 24 that is below the top surface 14. The recessed pocket 22 is surrounded by vertical walls 26 extending from the bottom floor surface 24 of the pocket to the top surface 14. In a preferred embodiment, the photoluminescent insert 28 is placed within the recessed pocket 22 and a transparent acrylic lens 30 is placed on top of the insert 28 and within the recessed pocket 22 so that side edges of the acrylic lens 30 are adjacent to the surrounding vertical walls 26 of the recessed pocket 22. Once in place, the surrounding peripheral edges of the acrylic lens 30 are electronically welded to the vertical side walls 26 and/or top surface 14 of the main body 12 so that the recessed pocket becomes completely sealed to prevent water, air or moisture from entering into the pocket 22 below the acrylic lens. This helps to protect the photoluminescent insert 28 from exposure to moisture, thereby prolonging the life of the luminescent raised pavement marker 10.

In the preferred embodiment, the sheet of paper substrate used to form the photoluminescent insert 28 has a thickness of between 35 mils and 55 mils, and preferably 45 mils. At least the top surface of the sheet substrate is coated with seven or more layers of the photoluminescent composition. Alternatively, the entire paper substrate may be dipped within the photoluminescent composition and allowed to dry, with repeated dipping of the sheet substrate within the photoluminescent composition to apply the multiple coats, and preferably at least seven coats (i.e., layers) of the photoluminescent composition.

As seen in FIG. 1, the front face 16 and opposite rear face 18 are provided with recessed pockets 34 that are specifically sized and configured for receipt of prismatic reflective lenses 32 therein. The prismatic reflective lenses 32 comply with U.S. Department of Transportation regulatory requirements for use on raised road markers (raised pavement markers) and can be of any approved color such as red, yellow, white, green and blue. In a preferred embodiment, the reflective lenses meet ASTM D788 Grade 8/ASTM D4280 requirements. The reflective lenses 32 are specifically sized to fit within the pockets 34 so that the edges of the reflective lenses 32 are engaged or are closely adjacent to either side edges of the recessed pockets 34. Once in place, the reflective lenses are electronically welded within the pockets. The pockets 34 are surrounded by a peripheral rim 36 that extends up above the surface of the front and rear faces 16,18, as well as above the top surface of the reflective lenses. The peripheral rim 36 helps to maintain the reflective lenses within the corresponding pockets 34, resisting the shearing forces of tires of automobiles, and particularly large heavy trucks, when driving over the raised pavement marker 10.

While the present invention has been shown and described in accordance with several preferred and practical embodiments, it is recognized that departures from the instant disclosure are fully contemplated within the spirit and scope of the present invention which is not to be limited except as defined in the following claims, as interpreted under the Doctrine of Equivalence.

What is claimed is:

1. A raised pavement marker comprising:
a main body integrally formed as a one piece monolithic structure and including a top portion with a top surface, a base with a bottom surface, a front face angled downwardly and outwardly from the top surface to the base, a rear face opposite the front face relative to the top portion and angled downwardly and outwardly from the top surface to the base, opposite end portions angled downwardly and outwardly from the top portion to the base, and a recessed pocket formed in the top portion and having a bottom floor surface and vertical walls extending from the bottom floor surface to the top surface;
an insert placed within the recessed pocket and formed of a sheet substrate having a top side facing upward, and the top side having multiple layers of a photoluminescent composition applied thereto, and the photoluminescent composition including at least one rare earth element;
a transparent lens placed in the recessed pocket and being congruently sized and configured for fitted receipt within the recessed pocket, and the transparent lens being electronically welded to the main body to seal the recessed pocket and prevent intrusion of liquid and moisture into the recessed pocket;
a first prismatic reflective lens attached to the front face of the main body;
a second prismatic reflective lens attached to the rear face of the main body;
the first and second prismatic reflective lenses each being surrounded by a raised peripheral lip that is integrally formed on the main body and structured and disposed to discourage movement and separation of the first and second prismatic reflective lenses from the main body; and
the bottom surface of the main body including a plurality of elongate open cavities for receiving a surface bonding adhesive material and increasing resistance against sheering forces exerted on the main body when the main body is adhered to an underlying application surface.

2. The raised pavement marker as recited in claim 1 wherein the sheet substrate has a thickness ranging between 35 mils and 55 mils.

3. The raised pavement marker as recited in claim 2 wherein the top side of the sheet substrate includes at least seven layers of the photoluminescent composition applied thereto.

4. The raised pavement marker as recited in claim 1 wherein the main body is formed of acrylonitrile butadiene styrene.

5. The raised pavement marker as recited in claim 1 wherein the main body is formed of at least one polycarbonate thermoplastic composition.

6. The raised pavement marker as recited in claim 1 wherein the main body is formed of a combination of acrylonitrile butadiene styrene and at least one polycarbonate thermoplastic composition.

7. The raised pavement marker as recited in claim 1 wherein the transparent lens is formed of acrylic.
